(19) United States
(12) Patent Application Publication
(10) Pub. No.: US 2026/0112650 A1
(43) Pub. Date: Apr. 23, 2026

(54) COMPOSITE CURRENT COLLECTORS INCLUDING A FIBROUS MEMBRANE AND A CONDUCTIVE MATERIAL AND/OR A METAL COATING

(71) Applicant: GM GLOBAL TECHNOLOGY OPERATIONS LLC, Detroit, MI (US)

(72) Inventors: Yong LU, Shanghai (CN); Meiyuan Wu, Shanghai (CN); Haijing Liu, Shanghai (CN); Jingyuan Liu, Shanghai (CN)

(21) Appl. No.: 18/980,833

(22) Filed: Dec. 13, 2024

(30) Foreign Application Priority Data
Oct. 22, 2024 (CN) 2024114818758

(51) Int. Cl. H01M 4/66; H01M 4/02; H01M 4/62; H01M 4/74; H01M 4/80

(52) U.S. Cl. CPC H01M 4/667; H01M 4/622; H01M 4/661; H01M 4/663; H01M 4/668; H01M 4/747; H01M 4/80; H01M 2004/021

(57) ABSTRACT

A battery cell includes A anode electrodes each including an anode active material layer arranged on an anode current collector, C cathode electrodes each including a cathode active material layer arranged on a cathode current collector, and S separators, where A, C, and S are integers greater than one. At least one of the anode current collector and the cathode current collector includes a composite current collector including a fibrous membrane coated with a conductive material.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to light weight composite current collectors including fibrous membranes.

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

Battery cells include cathode electrodes, anode electrodes, and separators. The cathode electrodes include a cathode active material layer (including cathode active material) arranged on a cathode current collector. The anode electrodes include an anode active material layer (including anode active material) arranged on an anode current collector.

### SUMMARY

A battery cell includes A anode electrodes each including an anode active material layer arranged on an anode current collector, C cathode electrodes each including a cathode active material layer arranged on a cathode current collector, and S separators, where A, C, and S are integers greater than one. At least one of the anode current collector and the cathode current collector includes a composite current collector including a fibrous membrane coated with a conductive material.

In other features, the fibrous membrane includes a material selected from a group consisting of polyester, polyolefin, polyphenylthiol, vinylon, and combinations thereof. The conductive material includes a material selected from a group consisting of a conductive carbon, a conductive polymer, and combinations thereof. The conductive carbon is selected from a group consisting of single walled carbon nanotubes (SWCNT), multi-walled carbon nanotubes (MWCNT), vapor grown carbon fibers (VGCF), carbon fibers, and combinations thereof.

In other features, the conductive polymer is selected from a group consisting of polypyrrole (PPy), polyaniline (PANI), polythiophene (PT), poly(3,4-ethylenedioxy thiophene) (PEDOT), poly(3,4-propylenedioxy thiophene) (PProDOT) and PEDOT:poly(4-styrene sulfonate) (PEDOT:PSS), polyacetylene (PA), poly(p-phenylenevinylene) (PPV), and combinations thereof. The fibrous membrane has a thickness in a range from 6 μm to 20 μm. The fibrous membrane has a porosity in a range from 45% to 85%.

In other features, the conductive material has a thickness in a range from 0.5 μm to 3 μm. A weight ratio of the conductive material to the fibrous membrane is in a range from 1 wt % to 15 wt %.

In other features, the cathode active material layer and the anode active material layer include active material in a range from 92 wt % to 97.5 wt %, conductive carbon in a range from 1 wt % to 3 wt %, and binder in a range from 1.5 wt % to 5 wt %. The binder is selected from a group consisting of polytetrafluoroethylene (PTFE), polyvinylidene difluoride (PVDF), polyvinylidene fluoride hexafluoropropylene PVDF-HFP, polyacrylic acid (PAA), styrene butadiene rubber (SBR), carboxymethyl cellulose (CMC), and combinations thereof.

A battery cell includes A anode electrodes each including an anode active material layer arranged on an anode current collector, C cathode electrodes each including a cathode active material layer arranged on a cathode current collector, and S separators, where A, C, and S are integers greater than one. At least one of the anode current collector and the cathode current collector includes a composite current collector including a fibrous membrane at least partially coated with a metal.

In other features, the fibrous membrane includes a material selected from a group consisting of polyester, polyolefin, polyphenylthiol, vinylon, and combinations thereof. The metal is selected from a group consisting of aluminum and copper. The metal fully permeates the fibrous membrane.

In other features, the fibrous membrane has a first thickness in a range from 6 μm to 20 μm, the metal coated fibrous membrane has a second thickness in a range from 7 μm to 25 μm, and a difference between the first thickness and the second thickness is in a range from 1 μm to 5 μm.

In other features, the metal partially permeates the fibrous membrane. An inner portion of the fibrous membrane is not coated with the metal and an outer portion of the fibrous membrane is coated with the metal wherein the metal on the outer portion of the fibrous membrane has a thickness in a range from 0.5 μm to 3 μm.

In other features, an inner portion of the fibrous membrane is coated with a conductive material and an outer portion of the fibrous membrane is coated with the metal wherein the metal on the outer portion of the fibrous membrane has a thickness in a range from 0.5 μm to 3 μm. The conductive material is selected from a group consisting of a conductive carbon and a conductive polymer.

In other features, the fibrous membrane has a thickness in a range from 6 μm to 20 μm. The fibrous membrane has a porosity in a range from 45% to 85%.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side cross section of an example of a battery cell including separators and anode electrodes and/or cathode electrodes including composite current collectors according to the present disclosure;

FIGS. 2A and 2B are side cross sections of an example of cathode electrodes and anode electrodes including composite current collectors according to the present disclosure;

FIG. 3A is a side cross section of an example of a current collector including a polymer layer coated by a conductive material;

FIG. 3B is a side cross section of an example of a composite current collector including a fibrous membrane and a coating including a conductive material according to the present disclosure;

FIG. 4 is a plan view of an example of a composite current collector including a fibrous membrane and a coating including a conductive material according to the present disclosure;

FIG. 5 is a functional block diagram illustrating an example of a method for manufacturing the composite current collector according to the present disclosure;

FIGS. 6 to 8 are side cross sections of other examples of composite current collectors including a fibrous membrane and a metal coating according to the present disclosure; and

FIG. 9 is a side cross section of an example of a battery cell including separators and anode electrodes and/or cathode electrodes including composite current collectors including fibrous material and a metal coating according to the present disclosure.

In the drawings, reference numbers may be reused to identify similar and/or identical elements.

### DETAILED DESCRIPTION

While battery cells according to the present disclosure are shown in the context of electric vehicles, the battery cells can be used in stationary applications and/or other applications.

In traditional lithium ion batteries (LIBs), conductive metal foils (e.g., typically aluminum (Al) and copper (Cu) foil) are used as current collectors for the cathode and anode electrodes, respectively. In the LIBs, current collectors (CCs) facilitate electron flow conduction between active material layers and external battery terminals. However, the current collectors are inert components with respect to lithium storage. The relatively high weight of the metal foil current collectors reduces the energy density of the battery cells. The high cost of the metal foils increases the price of the LIBs.

The present disclosure relates to composite current collectors incorporating light weight, fibrous membranes. In some examples, the fibrous membranes are coated with a conductive material. In other examples, the fibrous membranes are coated with a metal coating including copper, aluminum, or another suitable current collector metal. In still other examples, an inner portion of the fibrous membranes is coated with a conductive material and an outer portion of the fibrous membranes is coated with metal.

Tri-layered pouch cells with the composite current collectors (e.g., including the fibrous membrane coated with the conductive material) delivered an initial Coulombic efficiency (CE) higher than 93%, which is consistent with battery cells using metal foil current collectors. The composite current collector reduces cost and increases energy density by reducing mass while providing similar performance as battery cells using metal foil current collectors.

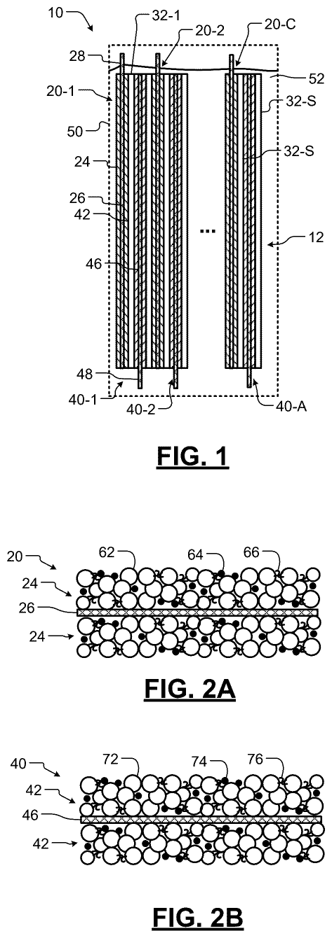

Referring now to FIG. 1, a battery cell 10 includes C cathode electrodes 20, A anode electrodes 40, and S separators 32 arranged in a predetermined sequence in a battery cell stack 12, where C, S and A are integers greater than one. The battery cell stack 12 is arranged in an enclosure 50. Liquid electrolyte 52 is added to the enclosure 50.

The C cathode electrodes 20-1, 20-2, . . . , and 20-C include a cathode active material layer 24 arranged on one or both sides of composite cathode current collectors 26 (described further below). The A anode electrodes 40-1, 40-2, . . . , and 40-A include anode active material layers 42 arranged on one or both sides of composite anode current collectors 46 (described further below). The S separators 32-1, 32-2, . . . , and 32-S are arranged between the C cathode electrodes 20 and the A anode electrodes 40.

In some examples, the A anode electrodes 40 and the C cathode electrodes 20 exchange lithium ions during charging/discharging. In some examples, the cathode active material layers 24 and/or the anode active material layers 42 comprise coatings including one or more active materials, one or more conductive additives, and/or one or more binder materials that are cast or applied onto one or both sides of the composite cathode current collectors 26 and/or the composite anode current collectors 46, respectively.

External tabs 28 and 48 are connected to the composite current collectors of the cathode electrodes and anode electrodes, respectively, and can be arranged on the same or different sides of the battery cell stack 12. The external tabs 28 and 48 are connected to terminals of the battery cells.

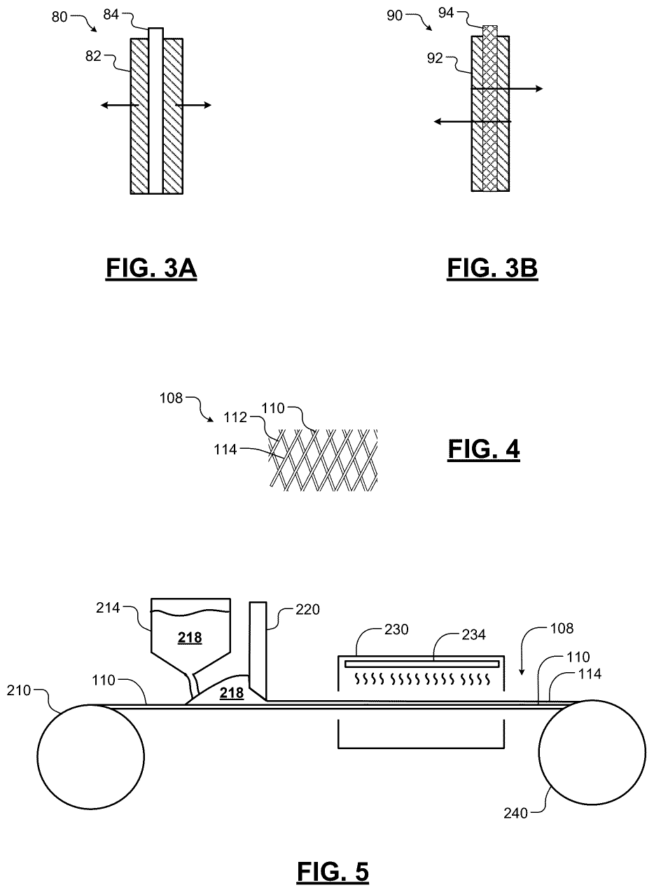

Referring now to FIGS. 2A and 2B, examples of the cathode and anode electrodes are shown. In FIG. 2A, one of the C cathode electrodes 20 is shown in more detail. The cathode active material layer 24 is arranged on the composite cathode current collector 26. The cathode active material layer 24 includes a cathode active material 62, a conductive additive 64, and a binder 66. In FIG. 2B, one of the A anode electrodes 40 is shown in more detail. The anode active material layer 42 is arranged on the composite anode current collector 46. The anode active material layer 42 includes an anode active material 72, a conductive additive 74, and a binder 76.

Referring now to FIGS. 3A and 3B, conventional current collectors or traditional composite current collectors and the composite current collectors according to the present disclosure perform differently. In FIG. 3A, a traditional composite current collector 80 includes a dense polymer layer 84 coated with a conductive material 82. The dense polymer layer 84 used in these types of composite current collectors or pure metal-based conventional current collectors blocks ionic communications of the electrode layers on the opposite two side of current collectors. In FIG. 3B, a composite current collector 90 includes a fibrous membrane 94 that is coated with a conductive material 92 when the composite current collector 90 is immersed in electrolyte allows ionic communications to occur across the current collector and reduces weight.

Referring now to FIG. 4, a composite current collector 108 includes a fibrous membrane 110 including fibers 112 that are interwoven and pores 113 located between the fibers 112. In some examples, the fibers 112 are coated and the pores 113 are filled with a conductive material 114. In other words, the conductive material 114 partially or fully permeates the fibrous membrane 110.

In some examples, the fibrous membrane 110 includes a material selected from a group consisting of polyester, polyolefin, polyphenylthiol, vinylon, and combinations thereof. In some examples, the conductive material 114 includes a material selected from a group consisting of a conductive carbon, a conductive polymer, and combinations thereof.

In some examples, the conductive carbon is selected from a group consisting of 1D carbons with high aspect ratios (e.g., greater than 10:1 aspect ratio). Examples of conductive carbon include single walled carbon nanotubes (SWCNT), multi-walled carbon nanotubes (MWCNT), vapor grown carbon fibers (VGCF), carbon fibers, and combinations thereof.

In some examples, the conductive polymer is selected from a group consisting of polypyrrole (PPy), polyaniline (PANI), polythiophene (PT), poly(3,4-ethylenedioxy thiophene) (PEDOT), poly(3,4-propylenedioxy thiophene) (PProDOT) and PEDOT:poly(4-styrene sulfonate) (PEDOT:PSS), polyacetylene (PA), poly(p-phenylenevinylene) (PPV), and combinations thereof.

In some examples, the fibrous membrane 110 has a thickness in a range from 6 μm to 20 μm. In some examples, the fibrous membrane 110 has a thickness in a range from 8 μm to 15 μm. In some examples, a porosity of the fibrous membrane 110 is in a range from 45% to 85%. In some examples, a porosity of the fibrous membrane 110 is in a range from 55% to 70%. In some examples, the conductive material 114 has a thickness in a range from 0.5 μm to 3 μm. In some examples, the conductive material 114 has a thickness in a range from 1.0 μm to 2 μm. In some examples, a weight ratio of the conductive material 114 relative to the fibrous membrane is in a range from 1 wt % to 15 wt %.

Referring now to FIG. 5, a method for manufacturing the composite current collector is shown. A roll 210 supplies a continuous sheet of fibrous membrane 110. A source 214 stores a conductive material slurry 218 dispenses the conductive material slurry 218 onto a surface of the fibrous membrane 110. A blade 220 may be used to control a thickness of the conductive material slurry 218. After coating, the fibrous membrane 110 and the conductive material 114 are heated for a predetermined period in an oven 230 including a heater 234 to remove the solvent and dry the conductive material 114. After heating, a roll 240 collects the composite current collector 108.

In some examples, the conductive material is mixed with a solvent and a binder to create the conductive material slurry 218. In some examples, the conductive material slurry 218 includes solvent in a range from 92% to 98.9 wt %, binder in a range from 1 to 5 wt %, and conductive material in a range from 0.01 wt % to 3 wt %.

In some examples, the solvent is selected from a group consisting of N-Methyl-2-pyrrolidone (NMP), water, and combinations thereof. In some examples, the binder is selected from a group consisting of polyvinylidene difluoride (PVDF), polyvinylidene fluoride hexafluoropropylene PVDF-HFP, polyacrylic acid (PAA), styrene butadiene rubber (SBR), carboxymethyl cellulose (CMC), and combinations thereof. In some examples, the oven is operated at a temperature greater than room temperature and less than the melting temperature of the fibrous membrane (e.g., about 80° C.).

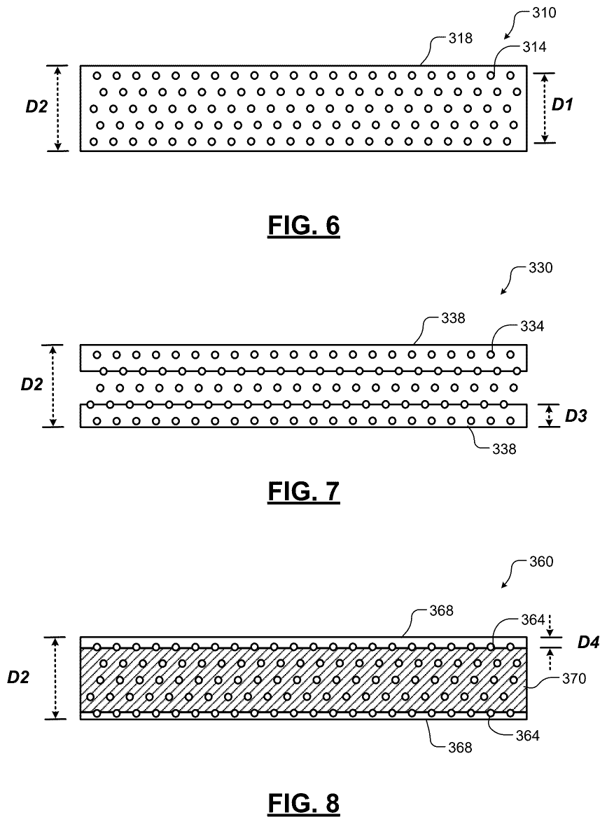

Referring now to FIGS. 6 to 8, metal can be coated onto the fibrous membrane instead of or in addition to coating the fibrous membrane with the conductive material. In FIG. 6, a composite current collector 310 includes a fibrous membrane 314 and a metal coating 318 coated onto the fibrous membrane 314. In this example, the metal coating 318 fully penetrates the fibrous membrane 314.

In some examples, the fibrous membrane 314 has a thickness D1 in a range from 6 μm to 20 μm. In other examples, the fibrous membrane 314 has a thickness D1 in a range from 8 μm to 15 μm. In some examples, a porosity of the fibrous membrane 314 is in a range from 45% to 85%. In other examples, the porosity of the fibrous membrane 314 is in a range from 55% to 70%.

In some examples, a thickness D2 of the metal coating 318 together with the fibrous membrane is in a range from 7 μm to 25 μm. In some examples, the thickness D2 of the metal coating 318 is in a range from 10 μm to 18 μm. In some examples, 1 μm≤(D2−D1)≤5 μm. In some examples, the metal in the metal coating 318 is selected from a group consisting of copper, aluminum, and/or other suitable metals used for anode or cathode current collectors.

In FIG. 7, a composite current collector 330 includes a fibrous membrane 334 including first and second metal coatings 338 coated on opposite surfaces thereof. The first and second metal coatings 338 partially penetrate outer portions of the fibrous membrane 334 from opposite sides. In some examples, a thickness D3 of each of the first and second metal coatings 338 is in a range from 0.5 μm to 5 μm.

In FIG. 8, a composite current collector 360 includes a fibrous membrane 364 including an inner portion. A conductive material 370 is embedded in the inner portion of the fibrous membrane 364. Outer surfaces of the fibrous membrane 364 and the conductive layer 370 are coated by first and second metal coatings 368. In some examples, a thickness D4 of each of the first and second metal coatings 368 is in a range from 0.5 μm to 3 μm.

In some examples, the metal coatings 318, 338, and/or 368 are sputtered into the pores and onto an outer surface of the fibrous membranes 314, 334, and 364, respectively. In other examples, the metal coatings 318, 338, and/or 368 are deposited into the pores and onto an outer surface of the fibrous membranes 314, 334, and 364, respectively, using evaporative deposition or electrochemical deposition.

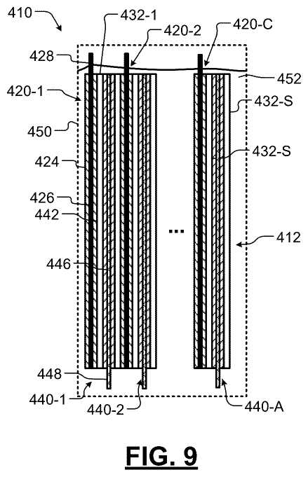

Referring now to FIG. 9, a battery cell 410 includes C cathode electrodes 420, A anode electrodes 440, and S separators 432 arranged in a predetermined sequence in a battery cell stack 412, where C, S and A are integers greater than one. The battery cell stack 412 is arranged in an enclosure 450. Liquid electrolyte 452 is added to the enclosure 450.

The C cathode electrodes 420-1, 420-2, . . . , and 420-C include a cathode active material layer 424 arranged on one or both sides of a composite cathode current collector 426. The composite cathode current collectors 426 include a fibrous membrane and a metal coating (such as aluminum or another suitable metal used in cathode current collectors) as described above in FIGS. 5 to 7.

The A anode electrodes 440-1, 440-2, . . . , and 440-A include anode active material layers 442 arranged on one or both sides of composite anode current collectors 446. The composite anode current collectors 446 include a fibrous membrane and metal coating (such as copper or another suitable metal used in anode current collectors) as described above in FIGS. 5 to 7. The S separators 432-1, 432-2, . . . , and 432-S are arranged between the C cathode electrodes 420 and the A anode electrodes 440. External tabs 428 and 448 are connected to the current collectors of the cathode electrodes and anode electrodes, respectively, and can be arranged on the same or different sides of the battery cell stack 412. The external tabs 428 and 448 are connected to terminals of the battery cells.

In the examples in FIGS. 1 and 9, the cathode and anode active material layers comprise active material in a range from 92 wt % to 97.5 wt %, conductive carbon in a range from 1 wt % to 3 wt %, and binder in a range from 1.5 wt % to 5 wt %. In some examples, the binder is selected from a group consisting of polytetrafluoroethylene (PTFE), polyvinylidene difluoride (PVDF), polyvinylidene fluoride hexafluoropropylene PVDF-HFP, polyacrylic acid (PAA), styrene butadiene rubber (SBR), carboxymethyl cellulose (CMC), and combinations thereof. When the PTFE binder is used, free-standing films can be used without a primer coating.

Tri-layered pouch battery cells including the composite anode and cathode current collectors (e.g., the fibrous membrane and the conductive material) provide comparable power output and high Coulombic efficiency (CE) (e.g., >93%) as compared to the same designs using copper foil and aluminum foil current collectors. For example, copper foil current collectors with a thickness of 6 μm have an aerial weight of 5.38 mg/cm², aluminum foil current collectors with a thickness of 12 μm have an aerial weight of 3.24 mg/cm², and composite current collectors with a thickness of 14 μm have an aerial weight of 1.11 mg/cm². The battery cell including the composite anode and cathode current collectors provided greater than 5% energy density improvement (assuming 100 Ah cell stack with energy density of 250 Wh/kg, and areal capacity loading of cathode of 4.0 mAh/cm²).

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is

1. A battery cell comprising:
A anode electrodes each including an anode active material layer arranged on an anode current collector;
C cathode electrodes each including a cathode active material layer arranged on a cathode current collector; and
S separators, where A, C, and S are integers greater than one,
wherein at least one of the anode current collector and the cathode current collector includes a composite current collector including a fibrous membrane coated with a conductive material.

2. The battery cell of claim 1, wherein the fibrous membrane includes a material selected from a group consisting of polyester, polyolefin, polyphenylthiol, vinylon, and combinations thereof.

3. The battery cell of claim 1, wherein the conductive material includes a material selected from a group consisting of a conductive carbon, a conductive polymer, and combinations thereof.

4. The battery cell of claim 3, wherein the conductive carbon is selected from a group consisting of single walled carbon nanotubes (SWCNT), multi-walled carbon nanotubes (MWCNT), vapor grown carbon fibers (VGCF), carbon fibers, and combinations thereof.

5. The battery cell of claim 3, wherein the conductive polymer is selected from a group consisting of polypyrrole (PPy), polyaniline (PANI), polythiophene (PT), poly(3,4-ethylenedioxy thiophene) (PEDOT), poly(3,4-propylenedioxy thiophene) (PProDOT) and PEDOT:poly(4-styrene sulfonate) (PEDOT:PSS), polyacetylene (PA), poly(p-phenylenevinylene) (PPV), and combinations thereof.

6. The battery cell of claim 1, wherein the fibrous membrane has a thickness in a range from 6 μm to 20 μm.

7. The battery cell of claim 1, wherein the fibrous membrane has a porosity in a range from 45% to 85%.

8. The battery cell of claim 1, wherein the conductive material has a thickness in a range from 0.5 μm to 3 μm.

9. The battery cell of claim 1, wherein a weight ratio of the conductive material to the fibrous membrane is in a range from 1 wt % to 15 wt %.

10. The battery cell of claim 1, wherein:
the cathode active material layer and the anode active material layer include active material in a range from 92 wt % to 97.5 wt %, conductive carbon in a range from 1 wt % to 3 wt %, and binder in a range from 1.5 wt % to 5 wt %, and
the binder is selected from a group consisting of polytetrafluoroethylene (PTFE), polyvinylidene difluoride (PVDF), polyvinylidene fluoride hexafluoropropylene PVDF-HFP, polyacrylic acid (PAA), styrene butadiene rubber (SBR), carboxymethyl cellulose (CMC), and combinations thereof.

11. A battery cell comprising:
A anode electrodes each including an anode active material layer arranged on an anode current collector;
C cathode electrodes each including a cathode active material layer arranged on a cathode current collector; and
S separators, where A, C, and S are integers greater than one,
wherein at least one of the anode current collector and the cathode current collector includes a composite current collector including a fibrous membrane at least partially coated with a metal.

12. The battery cell of claim 11, wherein the fibrous membrane includes a material selected from a group consisting of polyester, polyolefin, polyphenylthiol, vinylon, and combinations thereof.

13. The battery cell of claim 11, wherein the metal is selected from a group consisting of aluminum and copper.

14. The battery cell of claim 11, wherein the metal fully permeates the fibrous membrane.

15. The battery cell of claim 14, wherein:
the fibrous membrane has a first thickness in a range from 6 μm to 20 μm,
the metal coated fibrous membrane has a second thickness in a range from 7 μm to 25 μm,
and
a difference between the first thickness and the second thickness is in a range from 1 μm to 5 μm.

16. The battery cell of claim 11, wherein the metal partially permeates the fibrous membrane.

17. The battery cell of claim 16, wherein an inner portion of the fibrous membrane is not coated with the metal and an outer portion of the fibrous membrane is coated with the metal wherein the metal on the outer portion of the fibrous membrane has a thickness in a range from 0.5 μm to 3 μm.

18. The battery cell of claim 16, wherein an inner portion of the fibrous membrane is coated with a conductive material and an outer portion of the fibrous membrane is coated with the metal wherein the metal on the outer portion of the fibrous membrane has a thickness in a range from 0.5 μm to 3 μm.

19. The battery cell of claim 18, wherein the conductive material is selected from a group consisting of a conductive carbon and a conductive polymer.

20. The battery cell of claim 11, wherein:
the fibrous membrane has a thickness in a range from 6 μm to 20 μm; and
the fibrous membrane has a porosity in a range from 45% to 85%.
